(19) United States
(12) Patent Application Publication
(10) Pub. No.: US 2013/0093886 A1
(43) Pub. Date: Apr. 18, 2013

(54) METHOD AND SYSTEM FOR USING A VEHICLE-BASED DIGITAL IMAGERY SYSTEM TO IDENTIFY ANOTHER VEHICLE

(71) Applicant: Leigh M. ROTHSCHILD, Sunny Isles Beach, FL (US)

(72) Inventor: Leigh M. ROTHSCHILD, Sunny Isles Beach, FL (US)

(73) Assignee: ARIEL INVENTIONS, LLC, Sunny Isles Beach, FL (US)

(21) Appl. No.: 13/275,654

(22) Filed: Oct. 18, 2011

(51) Int. Cl. H04N 7/18

(52) U.S. Cl. 348/148; 348/E07.085

(57) ABSTRACT

Embodiments of the present invention provide a method, system and a vehicle identification computer for identifying a vehicle are disclosed. In accordance with an embodiment of the present invention, camera(s), mountable to a first vehicle, capture an image of at least a part of a second vehicle. The captured image includes vehicle identification indicia. An image file comprising the image and a tag are generated and transmitted to a vehicle identification computer. The vehicle identification computer identifies the second vehicle based on the vehicle identification indicia.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to vehicle identification and in particular to a method and system for identifying a vehicle using digital imagery.

### BACKGROUND OF THE INVENTION

Drivers contribute to keeping the roads safe when they call the police to report suspicious or illegal activity. A driver of a vehicle may decide to call the police in several situations. For example, a driver may call to report an accident, a speeding vehicle, a vehicle that keeps swerving in and out of traffic, or a vehicle travelling the wrong way on a one way street. The driver may decide to report the situation to the authorities, for example, by calling 911.

Generally, if a driver wants to report an incident to the police, the driver writes down the license plate number of the suspicious vehicle and uses a mobile phone to call the police. This requires the driver to take at least one hand off the steering wheel in order to write the license plate number down. Taking a hand off the steering wheel, even for a few seconds, significantly increases the chances of having an accident. Similarly, writing while driving requires the driver to divert his attention from the road and focus on the suspicious automobile's license plate, which is also dangerous.

In other instances, a driver may happen to witness an accident while the driver is talking on a mobile phone and, unless the driver terminates the current phone call, the driver cannot use the mobile phone to call the police to report the incident. The driver may not be able to or may not want to terminate the phone call, and instead, may choose to wait until the phone call is over to report the incident. This approach delays the transfer of information to the police, which then delays the police's response time to a critical situation.

The authorities encourage a driver that reports an incident to provide as much information as possible regarding the incident. A helpful driver may provide the police not only with a license plate number, but also with additional vehicle identification indicia, such as the color, make and model of a suspicious vehicle. The driver may also provide a location of the suspicious vehicle or a location of an incident involving the suspicious vehicle. Receiving vehicle identification indicia helps the authorities identify the suspicious vehicle. In some situations, if the driver is unable to see the license plate of the suspicious vehicle, the driver may decide that it is not worthy to call the police without the license plate number information. Some drivers may be able to recognize other vehicle identification indicia, such as the make and model of the suspicious vehicle, and may call the police with the information. However, other drivers may not be able to recognize the make and model of the suspicious vehicle, and may decide not to call the police, given that they are unable to provide the police with vehicle identification indicia.

What is needed is a method and system for obtaining and sending vehicle identification indicia to a third party to facilitate identification of the vehicle or vehicle occupants and the vehicle location.

### SUMMARY OF THE INVENTION

The present invention advantageously provides a method and system for using a vehicle-based digital imagery system to identify another vehicle. In accordance with one aspect, the invention provides a vehicle identification system that includes a camera, a processor and a transmitter. The camera is mountable to a first vehicle and captures an image of at least a part of a second vehicle. The image includes vehicle identification indicia. The processor generates an image file that includes the image and a tag. The transmitter sends the image file to a vehicle identification computer.

In accordance with another aspect, a method of identifying a first vehicle includes using a camera mountable to a second vehicle to capture an image of at least part of the first vehicle. The image includes vehicle identification indicia. An image file that includes the image and a tag is generated and sent to a vehicle identification computer.

According to another aspect, the invention provides a vehicle identification computer that includes a receiver and a processor. The receiver receives an image file from a vehicle identification system. The image file includes an image of at least a part of a vehicle and a tag. The image includes vehicle identification indicia. The receiver receives the image from a vehicle identification system. The processor identifies the vehicle based on the vehicle identification indicia.

In another embodiment, the image may also contain location information of the vehicle and speed information on the vehicle.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a diagram of a first vehicle using an exemplary vehicle identification system constructed in accordance with the principles of the present invention to capture an image of a second vehicle;

FIG. 2 is a block diagram of an exemplary image file according to the principles of the present invention;

FIG. 3 is a block diagram of an exemplary vehicle identification system according to the principles of the present invention;

FIG. 4 is a block diagram of an exemplary vehicle identification computer according to the principles of the present invention;

FIG. 5 is a flow chart of an exemplary process for identifying a vehicle by sending vehicle identification indicia to a vehicle identification computer, in accordance with the principles of the present invention; and

FIG. 6 is a flow chart of an exemplary process for identifying a vehicle by receiving and analyzing an image file, in accordance with the principles of the present invention.

### DETAILED DESCRIPTION OF THE INVENTION

Embodiments of the present invention provide a system, a method and a vehicle identification computer for using a vehicle-based digital imagery system to identify another vehicle. In accordance with an embodiment of the present invention, a camera mountable to a first vehicle captures an image of at least a part of a second vehicle. A processor generates an image file that includes the image and a tag. The image file may contain data related to the location of the second vehicle. The image file is transmitted to a vehicle identification computer to identify the second vehicle.

Before describing in detail exemplary embodiments that are in accordance with the present invention, it is noted that the embodiments reside primarily in combinations of apparatus components and processing steps related to implementing a method, system and a vehicle identification computer for using a vehicle-based digital imagery system to identify another vehicle. Accordingly, the system, method and vehicle identification computer components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

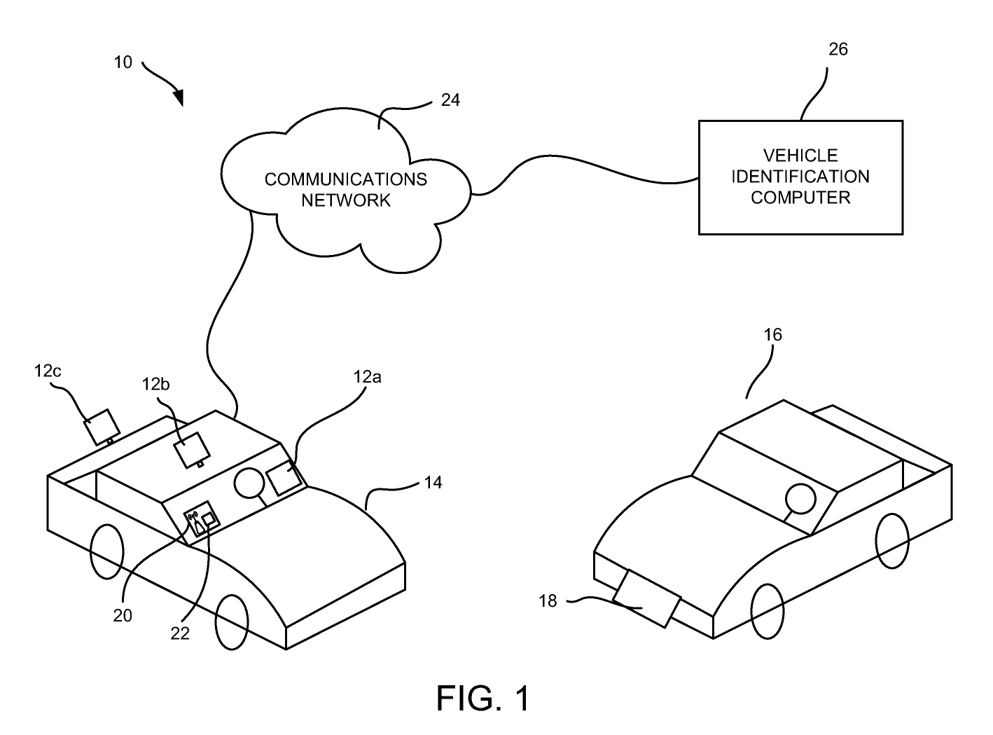

Referring now to the drawing figures in which reference designators refer to like elements, there is shown in FIG. 1 a schematic illustration of a system in accordance with the principles of the present invention, and generally designated as “10”. As shown in FIG. 1, cameras 12a, 12b and 12c (referred collectively herein as camera 12) may be mounted to a first vehicle 14. Cameras 12a, 12b and 12c may be placed in different parts of first vehicle 14. In an exemplary embodiment, camera 12a may be positioned on a dashboard of first vehicle 14, camera 12b may be positioned on the roof of first vehicle 14 and camera 12c may be positioned on the back of first vehicle 14. Cameras 12 may be digital cameras and may be configured to capture high resolution images. A driver of first vehicle 14 may use camera 12 to capture images of interest, where the images of interest may include second vehicle 16.

A driver of first vehicle 14 may capture, for example, an image of second vehicle 16 swerving in and out of traffic, speeding, driving aimlessly through a residential neighborhood, driving at night without headlights on, parking in a no parking zone in front of a government building, or parking illegally in a parking spot reserved for people with disabilities. A driver may also watch a driver of second vehicle 16 force someone into a vehicle, throw objects out of second vehicle 16, operate second vehicle 16 with a screwdriver in the ignition switch, operate second vehicle 16 while being under the influence of alcohol or drugs, or cause an accident.

The driver of first vehicle 14 may decide use camera 12 to capture an image of at least a part of a second vehicle 16. Camera 12 may comprise a signal processing unit for processing vocal commands. The driver of first vehicle 14 may operate camera 12 using vocal commands, pressing a button on camera 12, pressing a button on control unit 20 or using a mobile wireless device in communication with camera 12, and the like. Depending on the location of second vehicle 16 with respect to the location of first vehicle 14, at least one of camera 12a, 12b and 12c may be used to capture an image of at least a part of second vehicle 16. The driver of first vehicle 14 may send the captured image to a third party. In one embodiment, the third party may be the police.

Camera 12 may comprise one or multiple cameras. Camera 12 may work with visible spectrum light or with other portions of the electromagnetic spectrum. In an exemplary embodiment, camera 12 may be a thermographic or infrared camera. Camera 12 may use infrared radiation to capture an image and may operate in wavelengths above a range of wavelengths for a common visible light camera. As such, camera 12 may be an infrared camera that operates, for example, in wavelengths in the range of 14,000 nanometers. Camera 12 may capture radiation energy emanating from an object or a person as a function of their temperatures.

Camera 12 may be a night vision camera that senses radiation, such as near-infrared or ultraviolet radiation. Camera 12 may use image intensification technologies, thermal imaging technologies or magnification technologies to magnify the amount of received photons from sources. In one embodiment, camera 12 may be a thermal imaging camera commonly used by firefighters to see radiation energy through smoke and find persons. Further, camera 12 may be a camera generally used in government security applications or in military operations.

Camera 12 may have a lens made in a wide range of focal lengths. The lens may range from extreme wide angle, wide angle, standard, medium, etc. Additionally, camera 12 may be a single-lens reflex camera or a twin-lens reflex camera. Camera 12 may use a plurality of apertures, such as a wide aperture, a normal aperture and a small aperture. Camera 12 may have different focus modes, such as a fixed focus, long-focus or an adjustable focus. Camera 12 may have a shutter, such as a leaf shutter or a focal-plane shutter, and may have a zoom feature.

Camera 12 may be a still camera or a video camera. Camera 12 may have a user interface or may be voice operated. Camera 12 may be integrated with first vehicle 14, and may be controlled using a command control center of first vehicle 14. Camera 12 may be controlled with a user interface that responds to physical user input and/or voice commands. Camera 12 may be controlled by a mobile device. In one embodiment, camera 12 may include a display. Camera 12 may display a captured image on the display. Camera 12 may display the captured image on a display device of first vehicle 14. Camera 12 may communicate with the mobile device and display the image on a screen of the mobile device. Camera 12 may have a zoom feature that may be controlled via a user interface that responds to physical user input or voice commands and/or voice commands.

Control unit 20 may be mounted to first vehicle 14. Control unit 20 may be in communication with camera 12 and may receive an image captured by camera 12. Control unit 20 may process the image to generate image file 22, and may transmit image file 22 to communications network 24. In one embodiment, control unit 20 may transmit image file 22 using a wireless network such as a cellular communications network or a Wi-Fi network.

Control unit 20 may encrypt image file 22 before transmitting image file 22 to communications network 24. In an exemplary embodiment, image file 22 may be encoded so as to restrict access to image file 22 for unauthorized users. Image file 22 may comprise a BMP, JPG, JPEG, GIF, PNG or a TIFF image and may be compressed before being transmitted to communications network 24. In another exemplary embodiment, image file 22 may be transmitted anonymously to communications network 24.

Communications network 24 may receive image file 22 and may transmit image file 20 to a third party. In an exemplary embodiment, image file 22 may be transmitted to vehicle identification computer 26. Vehicle identification computer 26 may be connected to communications network 24 and may receive image file 22 via a wireless network such as a cellular communications network or a Wi-Fi network. Vehicle identification computer 26 may be associated with a government agency or private party. For example, vehicle identification computer 26 may be associated with one of a law enforcement agency, an insurance company, a security company, a police department, the FBI, or an individual. In one embodiment, vehicle identification computer may be associated with the owner of first vehicle 14. The owner of first vehicle 14 may be a company, such as an overnight courier.

Vehicle identification computer 26 may receive image file 22 and may process image file 22 to identify second vehicle 16. Vehicle identification computer 26 may analyze vehicle identification indicia in image file 22 using an optical character recognition computer program. Vehicle identification indicia may be, among other things, license plate number 18, a color of second vehicle 16, a vehicle type of second vehicle 16 and an image of one or more occupant of second vehicle 16. In an exemplary embodiment, vehicle identification computer 26 may use image identification algorithms, such as image interpolation or vector quantization, to analyze vehicle identification indicia in image file 22. Vehicle identification computer 26 may use a series of image manipulation techniques to detect, normalize and enhance the image of license plate number 18, and determine the alphanumeric characters of license plate number 18.

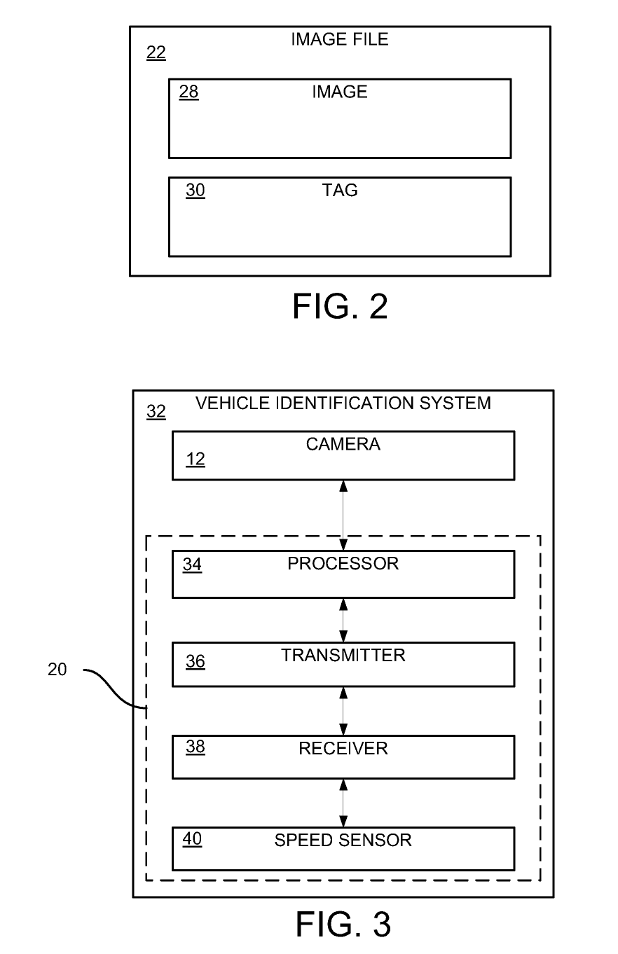

FIG. 2 is a block diagram of an exemplary image file 22 constructed in accordance with the principles of the present invention. Image file 22 may include image 28 and tag 30. Image 28 may include vehicle identification indicia associated with second vehicle 16. In an exemplary embodiment, vehicle identification indicia may be, among other things, license plate number 18, the make and model of second vehicle 16 and the color of second vehicle 16. Image 28 may also include an image of a driver of second vehicle 16, an image of a passenger of second vehicle 16, an image of the surroundings of second vehicle 16, an image showing visual conditions of the road, an image showing weather conditions, or an image showing traffic around second vehicle 16.

In addition to transmitting image 28 to vehicle identification computer 26, transmitter 36 may also transmit tag 30. In an exemplary embodiment, tag 30 may include a voice description of captured image 28. Tag 30 may include a description of second vehicle 16, the name of the city in which second vehicle 16 is located, the road name, road number, any mile markings, direction of travel of second vehicle 16, traffic signs proximate to second vehicle 16, lane identification, global positioning system information, a geographic location, such as a geographic location of second vehicle 16, a date, a time stamp, a velocity of first vehicle 14, an approximate velocity of second vehicle 16, a direction of travel of first vehicle 14, a direction of travel of second vehicle 16, and any other information that may be useful for identifying second vehicle 16. Vehicle 14 may include speed and location sensors in order to provide corresponding information as part of the image file.

In an exemplary embodiment, tag 30 may include a description of a car accident scene involving second vehicle 16, a description of the situation involving second vehicle 16, a description of other vehicles on the scene, such as police or emergency vehicles, a description of the driver of second vehicle 16 or a message.

Vehicle identification computer 26 may receive image file 22, which includes image 28 and tag 30. Vehicle identification computer 26 may determine which blocks contain vehicle identification indicia by dividing image 28 into small blocks, and analyzing pixel values within the small blocks. Vehicle identification computer 26 may code each of the small blocks according to their individual features. In one embodiment, the blocks may be coded according to whether or not the blocks contain relevant vehicle identification indicia. Vehicle identification computer 26 may use a computer program to determine whether vehicle identification indicia contained in image 28 contains recognizable information that can be used to identify second vehicle 16.

In an exemplary embodiment, vehicle identification indicia may include license plate number 18. Vehicle identification computer 26 may match license plate number 18 against a vehicle identification database to identify second vehicle 16. In another exemplary embodiment, vehicle identification computer 26 may analyze image file 22 to determine vehicle identification indicia such as, the color, make, model and year of second vehicle 16. Vehicle identification computer 26 may match these characteristics against a vehicle identification database to identify second vehicle 16. Vehicle identification computer 26 may also identify a driver and a passenger of second vehicle 16 by analyzing image 28 using facial recognition software. Vehicle identification computer 26 may determine whether second vehicle 16 is a stolen vehicle or whether an occupant of second vehicle 16 is a person wanted by the authorities.

FIG. 3 is a block diagram of an exemplary vehicle identification system 32 in accordance with the principles of the present invention. In an exemplary embodiment, vehicle identification system 32 may include camera 12 and control unit 20. Control unit 20 may include processor 34, transmitter 36 and receiver 38. Receiver 38 may be in communication with camera 12, and may receive image 28 from camera 12. Receiver 38 may also receive data from other sources like a GPS, a mobile device, or the driver of first vehicle 14. Receiver 38 may receive voice data from the driver of first vehicle 14 and may include the voice data in tag 30. Processor 34 may be in communication with camera 12, and may process image 28 and tag 30 to generate image file 22. Transmitter 36 may be in communication with camera 12, and may transmit image file 22 to vehicle identification computer 26 using communications network 24. At least one of cameras 12a, 12b and 12c may include a zoom that may be controlled by a user interface that responds to physical user input and/or by voice commands.

Control unit 20 may include speed sensor 40. Speed sensor 40 may capture a speed of second vehicle 16. Speed sensor 40 may include position sensing technology and signal-processing circuitry. In an exemplary embodiment, speed sensor 40 may include a radar. The radar may be configured to calculate the speed of second vehicle 16 by sending a radio wave that bounces from second vehicle 16 back to the radar. The radar may detect a change in frequency of the bounced radio wave and analyze the difference in frequency between the sent radio wave and the bounced radio wave. The radar may use the Doppler effect calculate the velocity of vehicle 16 relative to first vehicle 14. Speed sensor 40 may be a stationary radar or a moving radar that may be used while first vehicle 14 is in motion. In another exemplary embodiment, speed sensor 40 may use a laser to send pulses of light and make speed calculations using time and distance measurements.

In an exemplary embodiment, processor 34 may process image file 22 to determine vehicle identification indicia. Processor 34 may extract relevant vehicle identification indicia contained in image file 22. Vehicle identification indicia may include license plate number 18. Processor 34 may match license plate number 18 against a vehicle identification database to identify second vehicle 16. In another exemplary embodiment, processor 34 may analyze image file 22 to determine vehicle identification indicia such as, the color, model, make and year of second vehicle 16. Processor 34 may match these characteristics against a vehicle identification database to identify second vehicle 16. Processor 34 may also identify a driver and a passenger of second vehicle 16 by analyzing image 28 using facial recognition software.

Processor 34 may process image file 22 and identify vehicle identification indicia, such as license plate number 18, using an optical character recognition computer program. In an exemplary embodiment, processor 34 may use image identification algorithms, such as image interpolation or vector quantization, to analyze vehicle identification indicia in image 28. Processor 34 may use a series of image manipulation techniques to detect, normalize and enhance the image of license plate number 18, and determine the alphanumeric characters of license plate number 18.

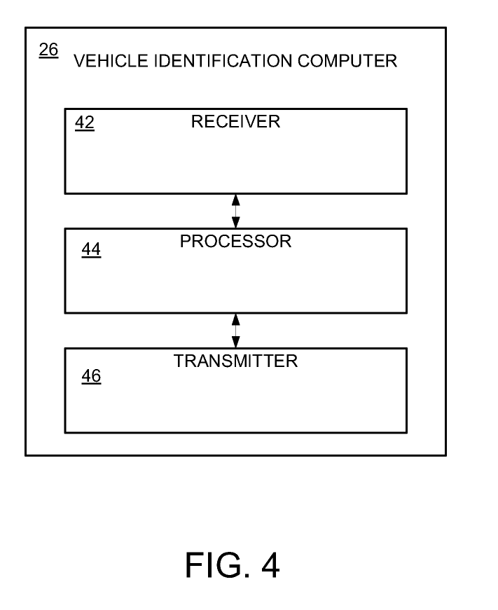

FIG. 4 is a block diagram of an exemplary vehicle identification computer 26 constructed in accordance with the principles of the present invention. Vehicle identification computer 26 may include receiver 42, processor 44 and transmitter 46. Receiver 42 may receive image file 22 from vehicle identification system 32. Vehicle identification computer 26 may identify second vehicle 16 based on vehicle identification indicia in image file 22. Transmitter 46 may transmit information in response to receiving image file 22. In one embodiment, information may be a warning message or an instruction message. The message may be transmitted to vehicle identification system 32. Examples of warning and instruction messages include: “Dangerous Criminal,” “Stay Away,” “Leave Scene Immediately,” “Proceed with Caution,” “Wanted Person,” “Stolen Vehicle,” etc. A message may also be sent to law enforcement, an insurance company, a security company, a police department, the FBI, and the like, with additional details, including the identity of the second vehicle, its owner, etc.

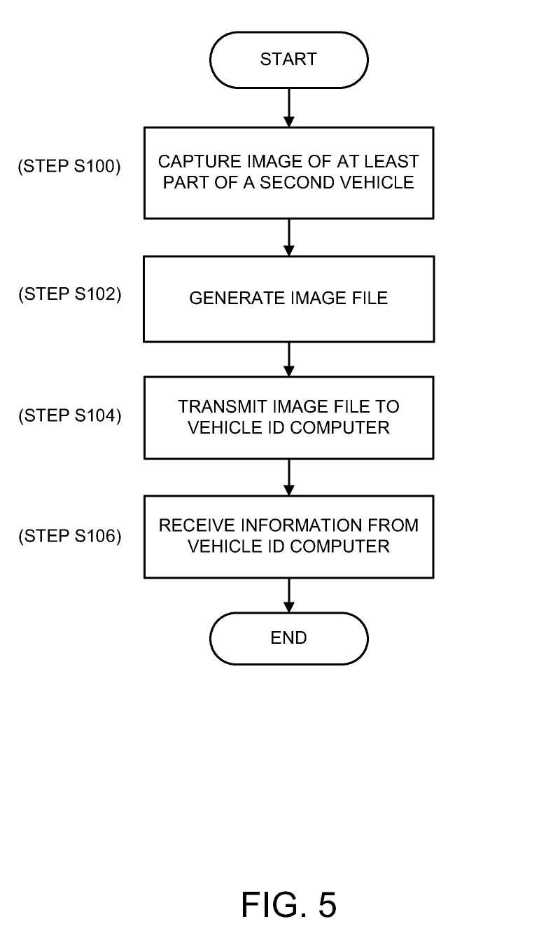

FIG. 5 is a flow chart of an exemplary method for identifying a vehicle according to the principles of the present invention. At least part of second vehicle 16 may be captured in image 28 (Step S100). Image file 22, containing image 28 and tag 30, is generated (Step S102). Image file 22 may include vehicle identification indicia that may be used to identify second vehicle 16. Image file 22 is transmitted to vehicle identification computer 26 (Step S104). Image file 22 may be transmitted to vehicle identification computer 26 using communications network 24. Vehicle identification system 32 may receive information from vehicle identification computer 26 (Step 106) in response to transmitting image file 22 to vehicle identification computer 26. The information may include a warning or instruction message.

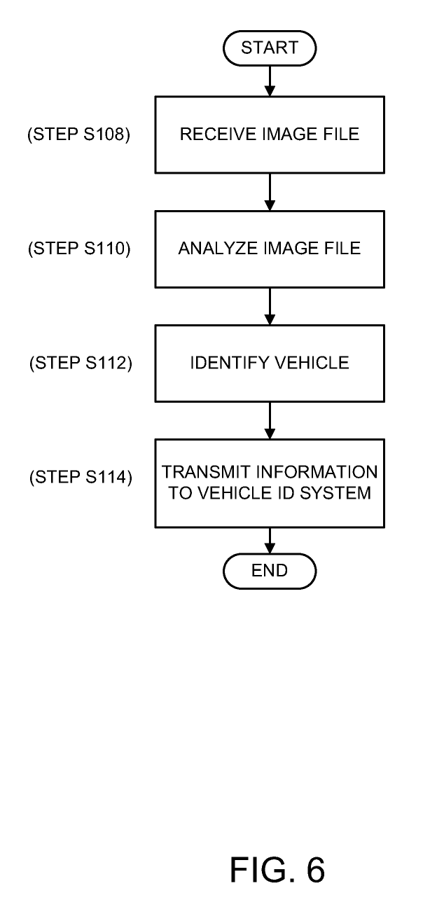

FIG. 6 is a flow chart of a method performed by vehicle identification computer 26 for identifying second vehicle 16. Image file 22 is received (Step S108) and then analyzed (Step S110). Second vehicle 16 is identified using techniques as described herein (Step S112). Information, such as warning or instruction message, is transmitted (Step S114) to vehicle identification system 32, to wireless device of the driver or occupant of the first vehicle and or to a law enforcement agency, an insurance company, a security company, a police department, the FBI, and the like.

The present invention can be realized in hardware or a combination of hardware and software. Any kind of computing system, or other apparatus adapted for carrying out the methods described herein, is suited to perform the functions described herein.

A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program, software or application in the present context means any expression, in any language, code or notation, of a set of instructions intended to cause a system having an information processing capability to perform a particular function either directly or after either or both of the following a) conversion to another language, code or notation; b) reproduction in a different material form.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A vehicle identification system, comprising:
a camera, the camera being mountable to a first vehicle, the camera capturing an image of at least a part of a second vehicle, the image including vehicle identification indicia;
a processor in communication with the camera, the processor generating an image file comprising the image and a tag; and
a transmitter in communication with the processor, the transmitter sending the image file to a vehicle identification computer.

2. The vehicle identification system of claim 1, wherein:
the tag includes at least one of a voice description of the captured image, a geographic location, a date stamp, a velocity and a time stamp;
the geographic location includes at least one of a first vehicle geographic location and a second vehicle geographic location; and
the velocity includes at least one of a first vehicle velocity and a second vehicle velocity.

3. The vehicle identification system of claim 1, wherein the vehicle identification indicia is at least one of a license plate number, a make, a model, a color and a year of second vehicle.

4. The vehicle identification system of claim 3, wherein the processor further processes the vehicle identification indicia to identify the license plate number of the second vehicle.

5. The vehicle identification system of claim 1, further comprising a mobile wireless communication device, wherein the transmitter is part of the mobile wireless communication device.

6. The vehicle identification system of claim 1, further comprising a receiver, wherein the receiver receives a message in response to transmitting the image file, the message including at least one of a warning message and an instruction message.

7. The vehicle identification system of claim 1, wherein the vehicle identification computer is associated with one of a law enforcement agency, an insurance company, a security company and an owner of the first vehicle.

8. The vehicle identification system of claim 1, further comprising a velocity sensor, the velocity sensor capturing the velocity of the second vehicle.

9. The vehicle identification system of claim 1, further comprising a plurality of cameras being mountable to the first vehicle, at least one of the plurality of cameras capturing data associated with the second vehicle.

10. The vehicle identification system of claim 9, wherein at least one of the plurality of cameras is controlled using a user interface that responds to at least one of physical user input and voice commands.

11. A method of identifying a first vehicle, the method comprising:
using a camera mountable to a second vehicle to capture an image of at least part of the first vehicle, the image including vehicle identification indicia;
generating an image file comprising the image and a tag; and
transmitting the image file to a vehicle identification computer.

12. The method of claim 11, wherein:
the tag includes at least one of a voice description of the captured image, a geographic location, a date stamp, a velocity and a time stamp;
the geographic location includes at least one of a first vehicle geographic location and a second vehicle geographic location; and
the velocity includes at least one of a first vehicle velocity and a second vehicle velocity.

13. The method of claim 11, wherein the vehicle identification indicia is at least one of a license plate number, a make, a model, a color and a year of first vehicle.

14. The method of claim 11, further comprising controlling the camera with a user interface that responds to at least one of physical user input and voice commands.

15. The method of claim 11, wherein a mobile wireless communication device transmits the image file to the vehicle identification computer.

16. The method of claim 11, further comprising receiving a message in response to transmitting the image file, the message including at least one of a warning message and an instruction message.

17. The method of claim 11, wherein the vehicle identification computer is associated with one of a law enforcement agency, an insurance company, a security company and an owner of the second vehicle.

18. A vehicle identification computer, comprising:
a receiver, the receiver receiving an image file from a vehicle identification system, the image file comprising an image of at least a part of a vehicle and a tag, the image including vehicle identification indicia; and
a processor in communication with the receiver, the processor configured to identify the vehicle based on the vehicle identification indicia.

19. The vehicle identification computer of claim 18, wherein:
the tag includes at least one of a voice description of the captured image, a geographic location, a date stamp, a velocity, and a time stamp;
the geographic location includes at least one of a first vehicle geographic location and a second vehicle geographic location; and
the velocity includes at least one of a first vehicle velocity and a second vehicle velocity.

20. The vehicle identification computer of claim 18, wherein the vehicle identification indicia is at least one of a license plate number, a make, a model, a color and a year of second vehicle.

21. The vehicle identification computer of claim 18, wherein the vehicle identification indicia is an image of at least one of a driver and a passenger in the vehicle

22. The vehicle identification computer of claim 18, further comprising a transmitter in communication with the processor, wherein the transmitter sends a message in response to receiving the image file, the message including at least one of a warning message and an instruction message.

23. The vehicle identification computer of claim 22, wherein at least one of the warning message and the instruction message are sent to the vehicle identification system.
